(19) United States
(12) Patent Application Publication
(10) Pub. No.: US 2013/0256585 A1
(43) Pub. Date: Oct. 3, 2013

(54) METHOD OF FORMING FERRITE THIN FILM AND FERRITE THIN FILM OBTAINED USING THE SAME

(71) Applicant: MITSUBISHI MATERIALS CORPORATION, Tokyo (JP)

(72) Inventors: Toshihiro Doi, Naka-shi (JP); Hideaki Sakurai, Naka-shi (JP); Kenzo Nakamura, Naka-shi (JP); Kazunori Igarashi, Naka-shi (JP); Nobuyuki Soyama, Naka-shi (JP)

(73) Assignee: MITSUBISHI MATERIALS CORPORATION, Tokyo (JP)

(21) Appl. No.: 13/833,890

(22) Filed: Mar. 15, 2013

(30) Foreign Application Priority Data
Mar. 29, 2012 (JP) 2012-076987

(51) Int. Cl. H01F 41/22

(52) U.S. Cl. CPC H01F 41/22
USPC 252/62.62; 427/130

(57) ABSTRACT

A method of forming a ferrite thin film by carrying out a process for forming a coated film by coating a ferrite thin film-forming composition on a heat-resistant substrate and a process for calcining the coated film once or a plurality of times so that the thickness of the calcined film on the substrate becomes a desired thickness, and firing the calcined film formed on the substrate, in which the conditions for firing the calcined film formed on the substrate are under the atmosphere or an oxygen gas or inert gas atmosphere, a temperature-rise rate of 1° C./minute to 50° C./minute, a holding temperature of 500° C. to 800° C., and a holding time of 30 minutes to 120 minutes.

### TECHNICAL FIELD

The present invention relates to a method of forming a high characteristic ferrite thin film on a substrate at low cost using a sol-gel method.

### BACKGROUND ART

In a ferrite thin film, since the eddy-current loss is small in a high-frequency area due to its high permeability and high electric resistance, the ferrite thin film is used as a magnetic core material of a high-frequency inductor or transistor.

The ferrite thin film is formed using a variety of methods, such as a sputtering method, a deposition method, a plating method, a powder beam method, a sol-gel method, and a plasma MOCVD method. However, it is necessary to introduce an expensive apparatus to a vacuum process method such as a sputtering method or a CVD method, and therefore there is a problem in that the initial investment increases. In addition, in a spin spraying method in which non-electrolytic plating is applied, there was a merit that a ferrite film can be manufactured using a relatively cheap apparatus, but a liquid including a large amount of raw materials is used during film formation, which is not preferable in terms of the environment. Meanwhile, a sol-gel method is attracting attention since a vacuum apparatus or the like is not used, which makes the film forming process cheap, and a uniform film composition can be obtained in the surface of a substrate.

Thus far, as a method of forming a ferrite thin film using a sol-gel method, Non Patent Document 1 has been reported. In Non Patent Document 1, a mixed solution including iron nitrate, nickel nitrate, N,N-dimethylformamide, zinc acetate and copper nitrate is coated on a Si substrate having SiO₂ formed thereon using a spin coating method, dried at 120° C. for 10 minutes so as to remove the solvent, and heated at 400° C. for 30 minutes so as to be thermally decomposed. In addition, after coating, drying and heating are repeated until a desire film thickness is attained, the solution is fired under RTA conditions of a temperature-rise rate of 150° C./second, a holding temperature of 400° C. to 700° C., and a holding time of 1 minute to 10 minutes, thereby manufacturing a Ni_{0.4}Cu_{0.2}Zn_{0.4}Fe₂O₄ ferrite thin film having a film thickness of 4000 Å (400 nm).

### RELATED ART DOCUMENT

### Non Patent Document

[Non Patent Document 1] Journal of Magnetism and Magnetic Materials, 309 (2007) p. 75 to 79 (2. Experimental on p. 75 and 76)

### DISCLOSURE OF THE INVENTION

### Problem that the Invention is to Solve

However, when the method of the related art, described in Non Patent Document 1, was used, cracking, which is a demerit of the sol-gel method, occurred due to the temperature-rise condition, and therefore it was difficult to obtain a film thickness of approximately several μm which is required for a magnetic thin film-mounted device. Specifically, it is considered that, under the above firing conditions, a tensile stress derived from the contraction of the film is generated during firing; however, in the case of a thick film having a film thickness of 1 μm or more, the tensile stress becomes larger such that cracking occurs. In addition, a large tensile stress was applied to the film such that deterioration of the characteristics was caused.

An object of the invention is to provide a method of forming a ferrite thin film in which it is possible to manufacture a thick film having a film thickness of 1 μm or more using a sol-gel method without causing cracking.

Another object of the invention is to provide a ferrite thin film having a thick film with a film thickness of 1 μm or more for which magnetic characteristics are improved.

### Means for Solving the Problems

A first aspect of the invention is a method of forming a ferrite thin film by carrying out a process for forming a coated film by coating a ferrite thin film-forming composition on a heat-resistant substrate and a process for calcining the coated film once or a plurality of times so that the thickness of the calcined film on the substrate becomes a desired thickness, and firing the calcined film formed on the substrate, in which the conditions for firing the calcined film formed on the substrate are under the atmosphere or an oxygen gas or inert gas atmosphere, a temperature-rise rate of 1° C./minute to 50° C./minute, a holding temperature of 500° C. to 800° C., and a holding time of 30 minutes to 120 minutes.

A second aspect of the invention is an invention based on the first aspect, in which, furthermore, the element composition of the ferrite thin film is NiZnFeO, CuZnFeO, or NiCuZnFeO.

A third aspect of the invention is an invention based on the first or second aspect, in which, furthermore, the conditions for calcining the coated film formed on the substrate are under the atmosphere or an oxygen gas atmosphere, a temperature of 100° C. to 450° C., and a holding time of 1 minute to 30 minutes.

A fourth aspect of the invention is a ferrite thin film obtained using the forming method based on the first to third aspects.

### Advantage of the Invention

In the method of forming a ferrite thin film of the invention, in order to suppress film contraction during firing, generation of a tensile stress is suppressed by using specific firing conditions, specifically, by increasing the temperature to the crystallization temperature at a temperature-rise rate extremely lower than the temperature-rise rate which was used in a sol-gel method of the related art so as to, intentionally, generate voids in the film. Thereby, it is possible to manufacture a ferrite thin film using a sol-gel method without causing cracking even when the film is a thick film having a film thickness of 1 μm or more.

In addition, in a ferrite thin film in which cracking occurs, the magnetic characteristics are poor, but the crack-free ferrite thin film of the invention, which is obtained using the above forming method, can improve the magnetic characteristics compared to a case in which cracking occurs.

### BRIEF DESCRIPTION OF THE DRAWINGS

FIG. 1 is a view showing the initial permeability of the ferrite thin films obtained in Examples 1-2, 2-2, and 3-2.

FIG. 2 is a photograph of the surface layer of the crack-free ferrite thin film obtained in Example 1-11 observed using a SEM.

FIG. 3 is a photograph of the cross-sectional surface of the crack-free ferrite thin film obtained in Example 1-11 observed using a SEM.

FIG. 4 is a photograph of the surface layer of the crack-free ferrite thin film obtained in Comparative example 1-1 observed using a SEM.

FIG. 5 is a photograph of the cross-sectional surface of the crack-free ferrite thin film obtained in Comparative example 1-1 observed using a SEM.

FIG. 6 is a graph showing the relationship between the temperature and the process time during firing in Examples 1-2 and 1-11 and Comparative example 2-2.

### BEST MODE FOR CARRYING OUT THE INVENTION

Next, embodiments for carrying out the invention will be described.

In the method of forming a ferrite thin film of the invention, first, a ferrite thin film-forming composition is coated on a heat-resistant substrate so as to form a coated film on the substrate. A heat-resistant substrate such as a silicon substrate or an alumina substrate is used as the substrate used to manufacture a ferrite thin film.

As a ferrite thin film to be formed, a NiZn ferrite, a CuZn ferrite, or a NiCuZn ferrite is preferable. The element composition of the NiZn ferrite thin film is NiZnFeO, and the composition is represented by (Ni₁₋ₓZnₓO)ₜ(here, 0.1≦x≦0.65, 0.95≦t≦1.05, 0.95≦s≦1.05, t+s=2), specifically, a component of (Ni_{0.36}Zn_{0.64}O) (Fe₂O₃), (Ni_{0.60}Zn_{0.40}O)(Fe₂O₃) or the like. In addition, the element composition of the CuZn ferrite thin film is CuZnFeO, and the composition is represented by (Cu₁₋ₓZnₓO)ₜ(Fe₂O₃)ₛ (here, 0.2≦x≦0.8, 0.95≦t≦1.05, 0.95≦s≦1.05, t+s=2), specifically, a component of (Cu_{0.04}Zn_{0.60}O)(Fe₂O₃), (Cu_{0.80}Zn_{0.20}O) (Fe₂O₃) or the like. In addition, the element composition of the NiCuZn ferrite thin film is NiCuZnFeO, and the composition is represented by (Ni_{0.80-x}Cu_{0.20}ZnₓO)ₜ(Fe₂O₃)ₛ (here, 0.1≦x≦0.7, 0.95≦t≦1.05, 0.95≦s≦1.05, t+s=2), specifically, a component of (Ni_{0.80}Cu_{0.20}Zn_{0.40}O) (Fe₂O₃), (Ni_{0.20}Cu_{0.20}Zn_{0.60}O) (Fe₂O₃) or the like.

In order to prepare the ferrite thin film-forming composition, a metal raw material is mixed so as to obtain a ratio corresponding to a desired ferrite thin film composition, dissolved in an appropriate solvent, and the concentration is adjusted to be suitable for coating. Examples of the metal raw material to be used include nitrates, acetates, and the like of metals (Ni, Zn, and Fe). In addition, the solvent is appropriately determined, according to the kind of the metal raw material to be used, and, generally, it is possible to use a solvent of acetonitrile, propylene glycol, butanol, 2-propanol, or ethanol. Meanwhile, the total concentration of the metal raw material in the ferrite thin film-forming composition is preferably set to appropriately 2 mass % to 10 mass % in terms of the amount of a metallic oxide.

Examples of a coating method of the ferrite thin film-forming composition onto the heat-resistant substrate include spin coating, dip coating, a liquid source misted chemical deposition (LSMCD) method, and the like. The film thickness of a coated film formed with a single time of coating is preferably 40 nm to 200 nm.

Next, the coated film formed on the substrate is calcined so as to form an amorphous-form calcined film. This process of calcining the coated film is preferably carried out using hot plate (HP), rapid thermal annealing (RTA), or the like.

The calcination conditions of the coated film formed on the substrate are under the atmosphere or an oxygen gas atmosphere, a temperature of 100° C. to 450° C., and a holding time of 1 minute to 30 minutes. An amorphous-form calcined film of a target substance can be obtained by carrying out calcination under the above conditions. Among the above, while slightly varying depending on the kind of the metal raw material to be used, the kind of the solvent, the total concentration of the metal raw material in the ferrite thin film-forming composition, and the film thickness of the coated film formed with a single time of coating, the calcination conditions are particularly preferably set to under the atmospheric atmosphere, a temperature of 600° C. to 800° C., and a holding time of 1 minute to 60 minutes.

In addition, a process for forming a coated film and a process for calcining the coated film is carried out once or a plurality of times so that the thickness of the calcined film on the substrate becomes a desired thickness. Here, the film thickness of the calcined film is set in consideration of the extent of densification in a firing process described below.

Next, the amorphous-form calcined film formed on the substrate is fired so as to form a ferrite thin film. This process for firing this calcined film is preferably carried out using an electric furnace, a muffle furnace, or the like.

A characteristic configuration of the invention is that the firing conditions of the calcined film formed on the substrate are set to under the atmosphere or an oxygen gas or inert gas atmosphere, a temperature-rise rate of 1° C./minute to 50° C./minute, a holding temperature of 500° C. to 800° C., and a holding time of 30 minutes to 120 minutes. In order to suppress film contraction during firing, intentionally, voids are generated in the film by using specific firing conditions, specifically, by increasing the temperature to the crystallization temperature at a temperature-rise rate extremely lower than the temperature-rise rate which was used in a sol-gel method of the related art. It is assumed that, when the generated voids suppress generation of a tensile stress which remains in the film, consequently, a crack-free ferrite thin film is formed.

The reasons for specifying the temperature-rise rate within the above range are that, while it is possible to obtain a ferrite thin film having no cracks and improved magnetic characteristics even at a temperature-rise rate as slow as less than the lower limit value, it takes too much time for the amorphous-form calcined film to reach the crystallization temperature during firing so as to cause a disadvantage of deterioration of the productivity, and, when the temperature-rise rate exceeds the upper limit value, it becomes difficult for the voids in the film to be generated such that it becomes impossible to suppress generation of a tensile stress in the film. In addition, the reasons for specifying the holding temperature within the above range are that, since the amorphous-form calcined film does not reach the crystallization temperature at a holding temperature of less than the lower limit value, a disadvantage is caused in which the film is not sufficiently crystallized such that amorphous-state places remain, and when the holding temperature exceeds the upper limit value, disadvantages are caused in terms of electrodes or wires on the substrate. Furthermore, the reasons for specifying the holding time within the above range is that a disadvantage is caused in which the film is not sufficiently crystallized such that amorphous-state places remain at a short holding time of less than the lower limit value, and, while it is possible to obtain a ferrite thin film having no cracks and improved magnetic characteristics even at a long holding time exceeding the upper limit value, it takes too much time, and a disadvantage of deterioration of the productivity is caused.

While slightly varying depending on the kind of the metal raw material to be used, the extent of the amorphous form in the calcined film, and the film thickness of the calcined film, the firing conditions are particularly preferably set to under the atmosphere, a temperature-rise rate of 5° C./minute to 10° C./minute, a holding temperature of 600° C. to 800° C., and a holding time of 30 minutes to 60 minutes.

Thereby, even when the film thickness is 1 μm or more, it is possible to manufacture a ferrite thin film using a sol-gel method without causing cracking.

The ferrite thin film of the invention is a ferrite film obtained using the forming method of the invention. It is known that the magnetic characteristics of a ferrite thin film in which cracking occurs become poor, in the crack-free ferrite thin film of the invention obtained using the above forming method, it is possible to improve the magnetic characteristics compared to a case in which cracking occurs.

### EXAMPLES

Next, examples of the invention will be described in detail along with comparative examples.

### Examples 1-1 to 1-16

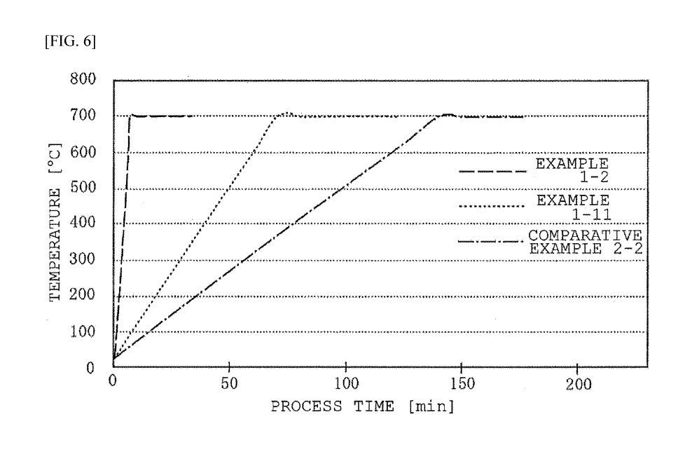

First, as a NiZn ferrite thin film-forming composition, a sol-gel liquid in which the concentration of a metallic oxide composed of nitrates of metals (Ni, Zn, and Fe) (nickel nitrate hexahydrate, zinc nitrate hexahydrate, iron nitrate nonahydrate), acetonitrile, propylene glycol, and butanol was 5 mass % was prepared. Meanwhile, the respective metals (Ni, Zn, and Fe) included in the sol-gel liquid were mixed in a ratio in which the composition of a thin film to be formed became (Ni_{0.36}Zn_{0.64}O)(Fe₂O₃). In addition, a Si/SiO₂ substrate was prepared. Next, the sol-gel liquid was added dropwise onto a Si/SiO₂ substrate, and spin coating was carried out at 3000 rpm for 15 seconds, thereby forming a coated film. In addition, this coated film-attached substrate was mounted on a hot plate heated under the conditions shown in the following table 1, and calcination was carried out, thereby thermally decomposing a precursor. This operation was repeated 5 times to 15 times, and an amorphous-form calcined film-attached substrate having a desired film thickness was obtained. Next, firing was carried out by putting the obtained amorphous-form calcined film-attached substrate into a muffle furnace, setting the inside of the furnace to the atmospheric atmosphere, rising the temperature from room temperature to the holding temperature at the temperature-rise rate shown in the following table 1, and holding the substrate at the holding temperature for the holding time shown in Table 1. Meanwhile, FIG. 6 shows the relationship between the temperature and the process time during firing in Examples 1-2 and 1-11. As a result of XRD measurements, it was confirmed that the obtained films were single-phase (Ni_{0.36}Zn_{0.64}O) (Fe₂O₃) films.

### Examples 2-1 to 2-16

First, as a CuZn ferrite thin film-forming composition, a sol-gel liquid in which the concentration of a metallic oxide composed of copper nitrate trihydrate, zinc acetate hexahydrate, iron nitrate nonahydrate, acetonitrile, propylene glycol, and butanol was 5 mass % was prepared. Meanwhile, the respective metals (Cu, Zn, and Fe) included in the sol-gel liquid were mixed in a ratio in which the composition of a thin film to be formed became (Cu_{0.40}Zn_{0.60}O) (Fe₂O₃). In addition, a Si/SiO₂ substrate was prepared. Next, the sol-gel liquid was added dropwise onto a Si/SiO₂ substrate, and spin coating was carried out at 3000 rpm for 15 seconds, thereby forming a coated film. In addition, this coated film-attached substrate was mounted on a hot plate heated under the conditions shown in the following table 1, and calcination was carried out, thereby thermally decomposing a precursor. This operation was repeated 5 times to 10 times, and an amorphous-form calcined film-attached substrate having a desired film thickness was obtained. Next, firing was carried out by putting the obtained amorphous-form calcined film-attached substrate into a muffle furnace, setting the inside of the furnace to an oxygen atmosphere, rising the temperature from room temperature to the holding temperature at the temperature-rise rate shown in the following table 1, and holding the substrate at the holding temperature for the holding time shown in Table 1. As a result of XRD measurements, it was confirmed that the obtained films were single-phase (Cu_{0.40}Zn_{0.60}O)(Fe₂O₃) films.

### Examples 3-1 to 3-16

First, as a NiCuZn ferrite thin film-forming composition, a sol-gel liquid in which the concentration of a metallic oxide composed of nickel acetate tetrahydrate, copper nitrate trihydrate, zinc acetate dihydrate, iron nitrate nonahydrate, acetonitrile, propylene glycol, and butanol was 5 mass % was prepared. Meanwhile, the respective metals (Ni, Cu, Zn, and Fe) included in the sol-gel liquid were mixed in a ratio in which the composition of a thin film to be formed became (Ni_{0.40}Cu_{0.20}Zn_{0.40}O)(Fe₂O₃). In addition, a Si/SiO₂ substrate was prepared. Next, the sol-gel liquid was added dropwise onto a Si/SiO₂ substrate, and spin coating was carried out at 3000 rpm for 15 seconds, thereby forming a coated film. In addition, this coated film-attached substrate was mounted on a hot plate heated under the conditions shown in the following table 1, and calcination was carried out, thereby thermally decomposing a precursor. This operation was repeated 5 times to 15 times, and an amorphous-form calcined film-attached substrate having a desired film thickness was obtained. Next, firing was carried out by putting the obtained amorphous-form calcined film-attached substrate into a muffle furnace, setting the inside of the furnace to a nitrogen atmosphere, rising the temperature from room temperature to the holding temperature at the temperature-rise rate shown in the following table 1, and holding the substrate at the holding temperature for the holding time shown in Table 1. As a result of XRD measurements, it was confirmed that the obtained films were single-phase (Ni_{0.40}Cu_{0.20}Zn_{0.40}O)(Fe₂O₃) films.

### Comparative Examples 1-1 to 1-3

Single-phase (Ni_{0.36}Zn_{0.64}O) (Fe₂O₃) films-attached substrates were obtained in the same manner as in Examples 1-1 to 1-16 except that the temperature-rise rates during firing of the amorphous-form calcined film-attached substrates were changed to a high temperature-rise rate shown in the following table 1.

### Comparative examples 2-1 to 2-2

Single-phase (Cu_{0.40}Zn_{0.60}O) (Fe₂O₃) films-attached substrates were obtained in the same manner as in Examples 2-1 to 2-16 except that the temperature-rise rates during firing of the amorphous-form calcined film-attached substrates were changed to a high temperature-rise rate shown in the following table 2. Meanwhile, FIG. 6 shows the relationship between the temperature and the process time during firing in Comparative example 2-2.

### Comparative Examples 3-1 to 3-2

Single-phase (Ni_{0.40}Cu_{0.20}Zn_{0.40}O) (Fe₂O₃) films-attached substrates were obtained in the same manner as in Examples 3-1 to 3-16 except that the temperature-rise rates during firing of the amorphous-form calcined film-attached substrates were changed to a high temperature-rise rate shown in the following table 3.

### Comparison Test 1

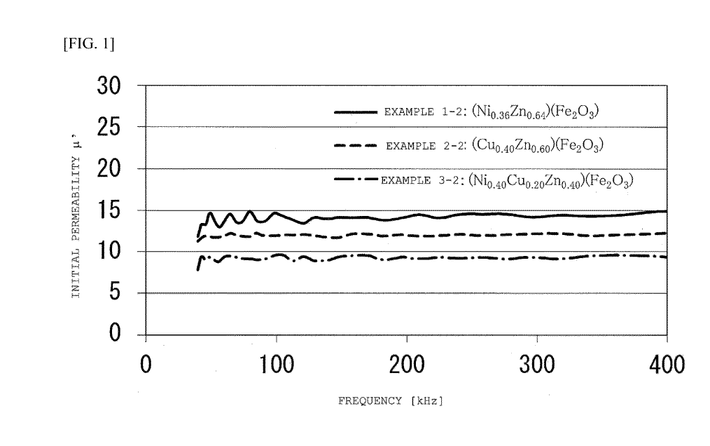

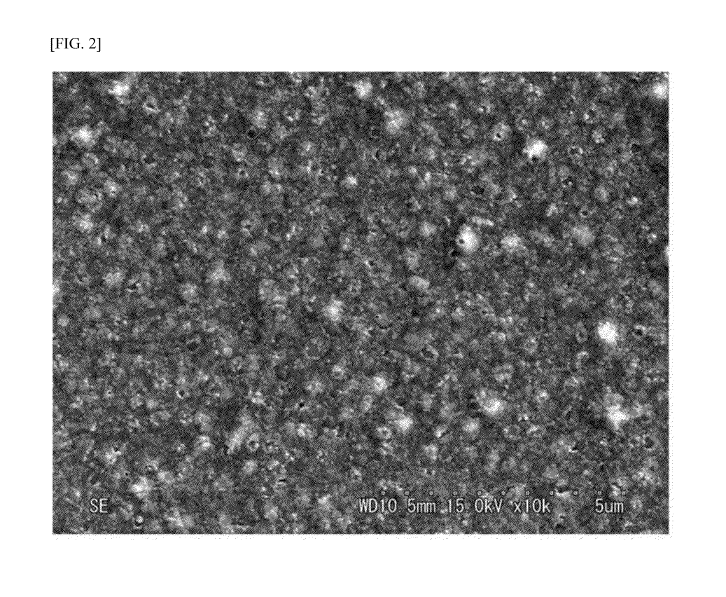

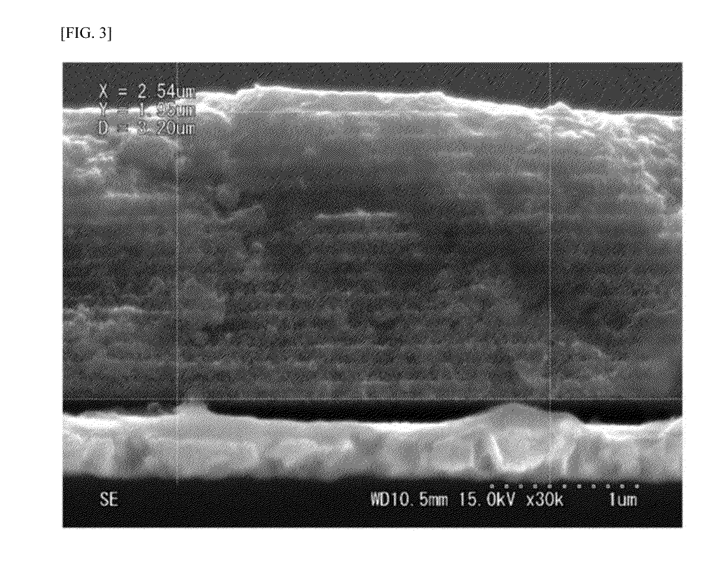

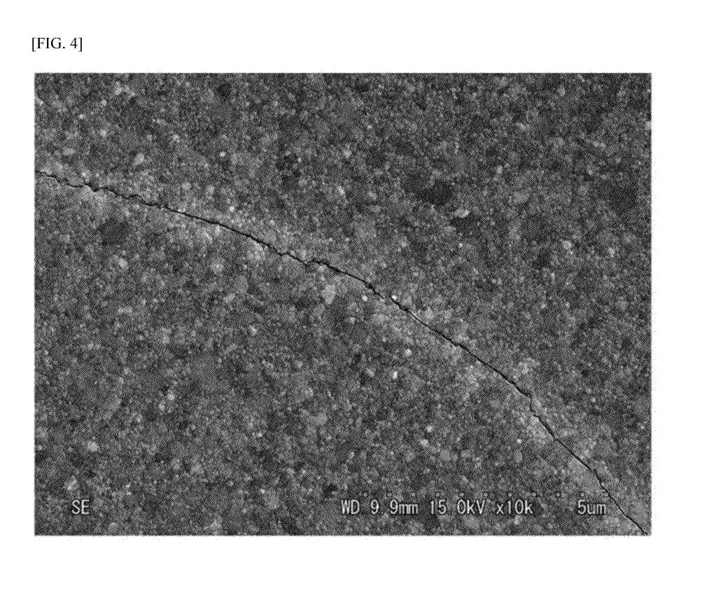

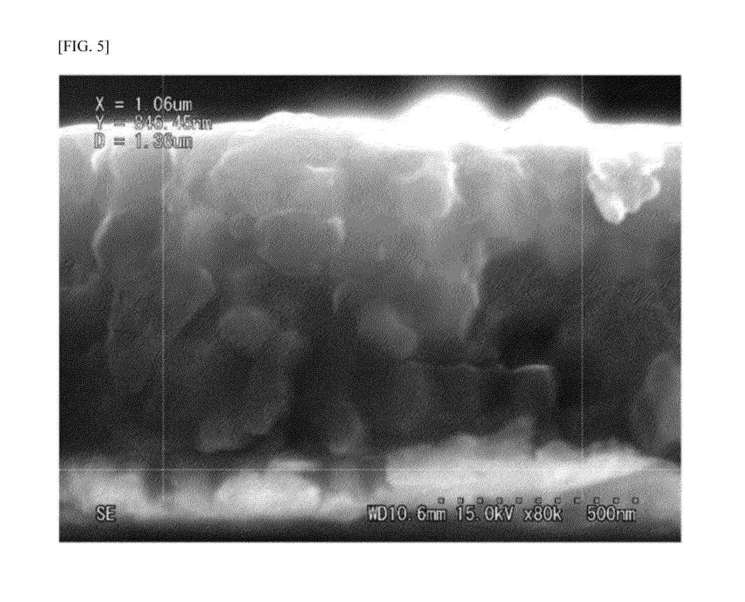

For the ferrite thin films obtained in the examples and the comparative examples, the film thicknesses, the presence or absence of cracks, and the initial permeability were obtained using the method shown below. The results are shown in the following tables 1 to 3. In addition, the initial permeability of the ferrite thin films obtained in Examples 1-2, 2-2, and 3-2 is shown in FIG. 1. In addition, photographs of the surface layers and cross-sections of the ferrite thin films obtained in Example 1-11 and Comparative example 1-1 observed using a Scanning Electron Microscope (SEM, manufactured by Hitachi, Ltd.: model S-4300SE) are shown in FIGS. 2 to 5.

The film thickness of the ferrite thin film was obtained by measuring the thickness of the cross-section of the formed thin film using the above SEM. In addition, the presence or absence of cracks was confirmed using SEM observation of the surface layers and cross-sections of the formed thin films as shown in the photographs. The initial permeability was measured at a frequency of up to approximately 40 MHz using an absolute permeability measuring apparatus impedance analyzer (manufactured by Agilent Technologies, product name HP4194A) and an air core coil manufactured using a copper wire. Meanwhile, FIG. 1 shows the measurement results of up to 400 kHz. The air core coil was manufactured by making an outer shape of a size into which a 1 cm×5 cm-sized wafer is fittingly inserted using a thin plate of an acryl resin or the like, and winding the copper wire onto the outer shape times to 80 times. After the inductance of the manufactured air core coil was measured using an impedance analyzer, a 1 cm×5 cm-sized ferrite thin film-attached substrate was inserted as a core, and the inductance was Measured again. At this time, the inductance difference ΔL before and after the insertion of the core can be obtained using the following formula (1), and therefore it is possible to measure the initial permeability of a ferrite thin film material.

ΔL=μ₀×μ′×S×N²/l (1)

However, in the above formula (1), μ₀ represents the permeability of a vacuum, μ′ represents the actual part of the complex permeability of the ferrite thin film (initial permeability), S represents the cross-sectional area of the ferrite thin film, N represents the winding number of the coil, and l represents the length of the coil.

TABLE 1

| | | Calcination | | Calcined | | | | | | |
|---|---|---|---|---|---|---|---|---|---|---|
| | Element | conditions | | film | Firing conditions | | | Ferrite thin film | | |
| | composition | Holding | Holding | Film | Temperature- | Holding | Holding | Film | Presence | |
| | of ferrite | temperature | time | thickness | rise rate | temperature | time | thickness | or absence | Initial |
| | thin film | [° C.] | [minutes] | [μm] | [° C./minute] | [° C.] | [minutes] | [μm] | of cracks | permeability |
| Example 1-1 | NiZnFeO | 400 | 5 | 1.80 | 1 | 700 | 60 | 1.30 | None | 8 |
| Example 1-2 | NiZnFeO | 400 | 5 | 1.80 | 10 | 700 | 60 | 1.20 | None | 15 |
| Example 1-3 | NiZnFeO | 400 | 5 | 1.80 | 20 | 700 | 60 | 1.20 | None | 12 |
| Example 1-4 | NiZnFeO | 400 | 5 | 1.80 | 50 | 700 | 60 | 1.10 | None | 10 |
| Example 1-5 | NiZnFeO | 400 | 5 | 1.80 | 5 | 500 | 60 | 1.50 | None | 5 |
| Example 1-6 | NiZnFeO | 400 | 5 | 1.80 | 5 | 600 | 60 | 1.35 | None | 8 |
| Example 1-7 | NiZnFeO | 400 | 5 | 1.80 | 5 | 800 | 60 | 1.15 | None | 15 |
| Example 1-8 | NiZnFeO | 400 | 5 | 1.80 | 5 | 700 | 30 | 1.20 | None | 15 |
| Example 1-9 | NiZnFeO | 400 | 5 | 1.80 | 5 | 700 | 90 | 1.20 | None | 15 |
| Example 1-10 | NiZnFeO | 400 | 5 | 1.80 | 5 | 700 | 120 | 1.20 | None | 15 |
| Example 1-11 | NiZnFeO | 400 | 5 | 1.50 | 5 | 700 | 60 | 1.00 | None | 15 |
| Example 1-12 | NiZnFeO | 400 | 5 | 3.00 | 5 | 700 | 60 | 2.00 | None | 15 |
| Example 1-13 | NiZnFeO | 100 | 5 | 2.00 | 5 | 700 | 60 | 0.60 | None | 7 |
| Example 1-14 | NiZnFeO | 450 | 5 | 1.70 | 5 | 700 | 60 | 1.20 | None | 15 |
| Example 1-15 | NiZnFeO | 400 | 1 | 1.95 | 5 | 700 | 60 | 1.30 | None | 10 |
| Example 1-16 | NiZnFeO | 400 | 30 | 1.80 | 5 | 700 | 60 | 1.20 | None | 15 |
| Comparative | NiZnFeO | 400 | 5 | 3.00 | 600 | 700 | 30 | 0.85 | Present | 8 |
| example 1-1 | | | | | | | | | | |
| Comparative | NiZnFeO | 400 | 5 | 1.80 | 100 | 700 | 60 | 1.05 | Present | 10 |
| example 1-2 | | | | | | | | | | |
| Comparative | NiZnFeO | 400 | 5 | 1.80 | 600 | 700 | 60 | 0.50 | Present | 8 |
| example 1-3 | | | | | | | | | | |

TABLE 2

| | | Calcination | | Calcined | | | | | | |
|---|---|---|---|---|---|---|---|---|---|---|
| | Element | conditions | | film | Firing conditions | | | Ferrite thin film | | |
| | composition | Holding | Holding | Film | Temperature- | Holding | Holding | Film | Presence | |
| | of ferrite | temperature | time | thickness | rise rate | temperature | time | thickness | or absence | Initial |
| | thin film | [° C.] | [minutes] | [μm] | [° C./minute] | [° C.] | [minutes] | [μm] | of cracks | permeability |
| Example 2-1 | CuZnFeO | 400 | 5 | 1.80 | 1 | 700 | 60 | 1.30 | None | 6 |
| Example 2-2 | CuZnFeO | 400 | 5 | 1.80 | 5 | 700 | 60 | 1.20 | None | 12 |
| Example 2-3 | CuZnFeO | 400 | 5 | 1.80 | 20 | 700 | 60 | 1.20 | None | 8 |
| Example 2-4 | CuZnFeO | 400 | 5 | 1.80 | 50 | 700 | 60 | 1.10 | None | 6 |
| Example 2-5 | CuZnFeO | 400 | 5 | 1.80 | 5 | 500 | 60 | 1.50 | None | 5 |
| Example 2-6 | CuZnFeO | 400 | 5 | 1.80 | 5 | 600 | 60 | 1.35 | None | 9 |
| Example 2-7 | CuZnFeO | 400 | 5 | 1.80 | 5 | 800 | 60 | 1.15 | None | 11 |
| Example 2-8 | CuZnFeO | 400 | 5 | 1.80 | 5 | 700 | 30 | 1.20 | None | 12 |
| Example 2-9 | CuZnFeO | 400 | 5 | 1.80 | 5 | 700 | 90 | 1.20 | None | 12 |
| Example 2-10 | CuZnFeO | 400 | 5 | 1.80 | 5 | 700 | 120 | 1.20 | None | 12 |
| Example 2-11 | CuZnFeO | 400 | 5 | 1.50 | 5 | 700 | 60 | 1.00 | None | 12 |
| Example 2-12 | CuZnFeO | 400 | 5 | 3.00 | 5 | 700 | 60 | 2.00 | None | 12 |
| Example 2-13 | CuZnFeO | 100 | 5 | 2.00 | 5 | 700 | 60 | 0.60 | None | 5 |
| Example 2-14 | CuZnFeO | 450 | 5 | 1.70 | 5 | 700 | 60 | 1.20 | None | 11 |
| Example 2-15 | CuZnFeO | 400 | 1 | 1.95 | 5 | 700 | 60 | 1.30 | None | 6 |
| Example 2-16 | CuZnFeO | 400 | 30 | 1.80 | 5 | 700 | 60 | 1.20 | None | 10 |
| Comparative | CuZnFeO | 400 | 5 | 1.80 | 100 | 700 | 30 | 1.05 | Present | 5 |
| example 2-1 | | | | | | | | | | |
| Comparative | CuZnFeO | 400 | 5 | 1.80 | 600 | 700 | 30 | 0.50 | Present | 5 |
| example 2-2 | | | | | | | | | | |

TABLE 3

| | | Calcination | | Calcined | | | | | | |
|---|---|---|---|---|---|---|---|---|---|---|
| | Element | conditions | | film | Firing conditions | | | Ferrite thin film | | |
| | composition | Holding | Holding | Film | Temperature- | Holding | Holding | Film | Presence | |
| | of ferrite | temperature | time | thickness | rise rate | temperature | time | thickness | or absence | Initial |
| | thin film | [° C.] | [minutes] | [μm] | [° C./minute] | [° C.] | [minutes] | [μm] | of cracks | permeability |
| Example 3-1 | NiCuZnFeO | 400 | 5 | 1.80 | 1 | 700 | 60 | 1.30 | None | 5 |
| Example 3-2 | NiCuZnFeO | 400 | 5 | 1.80 | 5 | 700 | 60 | 1.20 | None | 10 |
| Example 3-3 | NiCuZnFeO | 400 | 5 | 1.80 | 20 | 700 | 60 | 1.20 | None | 9 |
| Example 3-4 | NiCuZnFeO | 400 | 5 | 1.80 | 50 | 700 | 60 | 1.10 | None | 6 |
| Example 3-5 | NiCuZnFeO | 400 | 5 | 1.80 | 5 | 500 | 60 | 1.50 | None | 5 |
| Example 3-6 | NiCuZnFeO | 400 | 5 | 1.80 | 5 | 600 | 60 | 1.35 | None | 6 |
| Example 3-7 | NiCuZnFeO | 400 | 5 | 1.80 | 5 | 800 | 60 | 1.15 | None | 8 |
| Example 3-8 | NiCuZnFeO | 400 | 5 | 1.80 | 5 | 700 | 30 | 1.20 | None | 9 |
| Example 3-9 | NiCuZnFeO | 400 | 5 | 1.80 | 5 | 700 | 90 | 1.20 | None | 9 |
| Example 3-10 | NiCuZnFeO | 400 | 5 | 1.80 | 5 | 700 | 120 | 1.20 | None | 9 |
| Example 3-11 | NiCuZnFeO | 400 | 5 | 1.50 | 5 | 700 | 60 | 1.00 | None | 9 |
| Example 3-12 | NiCuZnFeO | 400 | 5 | 3.00 | 5 | 700 | 60 | 2.00 | None | 10 |
| Example 3-13 | NiCuZnFeO | 100 | 5 | 2.00 | 5 | 700 | 60 | 0.60 | None | 5 |
| Example 3-14 | NiCuZnFeO | 450 | 5 | 1.70 | 5 | 700 | 60 | 1.20 | None | 10 |
| Example 3-15 | NiCuZnFeO | 400 | 1 | 1.95 | 5 | 700 | 60 | 1.30 | None | 6 |
| Example 3-16 | NiCuZnFeO | 400 | 30 | 1.80 | 5 | 700 | 60 | 1.20 | None | 8 |
| Comparative | NiCuZnFeO | 400 | 5 | 1.80 | 100 | 700 | 30 | 1.05 | Present | 3 |
| example 3-1 | | | | | | | | | | |
| Comparative | NiCuZnFeO | 400 | 5 | 1.80 | 600 | 700 | 30 | 0.95 | Present | 5 |
| example 3-2 | | | | | | | | | | |

As is evident from Table 1 and FIGS. 1 to 5, in the NiZn ferrite thin films of Comparative examples 1-1 to 1-3 in which the temperature-rise rate during firing was set to a condition of more than 50° C./minute, cracking occurred in the surface layer, which resulted in a low permeability which shows the magnetic characteristics. On the other hand, in the NiZn ferrite thin films of Examples 1-1 to 1-16 in which the temperature-rise rate condition was set within a range of 1° C./minute to 50° C./minute, cracking did not occur in the surface layer, which resulted in a high permeability which shows the magnetic characteristics. It was confirmed from the above results that it is possible to obtain a ferrite thin film having improved magnetic characteristics without causing cracking even when the film thickness is several μm by setting the temperature-rise rate during firing to be low so as to suppress film contraction during firing.

In addition, as is evident from Tables 2 and 3 and FIG. 1, even for the CuZn ferrite thin films of Examples 2-1 to 2-16 and the NiCuZn ferrite thin films of Examples 3-1 to 3-16, similarly to the NiZn ferrite thin films of Examples 1-1 to 1-16, it was confirmed that a result in which cracking does not occur and the magnetic characteristics improve was obtained.

### INDUSTRIAL APPLICABILITY

The method of forming a ferrite thin film of the invention is to form a ferrite thin film having a thick film with a film thickness of 1 μm or more on a substrate of Si, aluminum, or the like using a sol-gel method, and the obtained ferrite thin film maintains a constant permeability up to a high frequency range of approximately 1 GHz to 2 GHz, and therefore, when the ferrite thin film is used in a thin film inductor which is used in a high frequency range, the Q value of the inductor can be improved, and the size of the inductor can be reduced.

1. A method of forming a ferrite thin film by carrying out a process for forming a coated film by coating a ferrite thin film-forming composition on a heat-resistant substrate and a process for calcining the coated film once or a plurality of times so that a thickness of the calcined film on the substrate becomes a desired thickness, and firing the calcined film formed on the substrate,
wherein conditions for firing the calcined film formed on the substrate are under the atmosphere or an oxygen gas or inert gas atmosphere, a temperature-rise rate of 1° C./minute to 50° C./minute, a holding temperature of 500° C. to 800° C., and a holding time of 30 minutes to 120 minutes.

2. The method of forming a ferrite thin film according to claim 1,
wherein an element composition of the ferrite thin film is NiZnFeO, CuZnFeO, or NiCuZnFeO.

3. The method of forming a ferrite thin film according to claim 1,
wherein conditions for calcining the coated film formed on the substrate are under the atmosphere or an oxygen gas atmosphere, a temperature of 100° C. to 450° C., and a holding time of 1 minute to 30 minutes.

4. A ferrite thin film obtained using the forming method according to claim 1.

5. The method of forming a ferrite thin film according to claim 2,
wherein conditions for calcining the coated film formed on the substrate are under the atmosphere or an oxygen gas atmosphere, a temperature of 100° C. to 450° C., and a holding time of 1 minute to 30 minutes.

6. A ferrite thin film obtained using the forming method according to claim 2.

7. A ferrite thin film obtained using the forming method according to claim 3.

8. A ferrite thin film obtained using the forming method according to claim 5.
